(19) United States
(12) Patent Application Publication
(10) Pub. No.: US 2008/0222979 A1
(43) Pub. Date: Sep. 18, 2008

(54) Frame Extension

(76) Inventor: Todd Eric Rissmiller, Lancaster, PA (US)

Correspondence Address: BARLEY SNYDER, LLC, 1000 WESTLAKES DRIVE, SUITE 275, BERWYN, PA, 19312, US

(21) Appl. No.: 12/042,136

(22) Filed: Mar. 4, 2008

Related U.S. Application Data
(60) Provisional application No. 60/918,623, filed on Mar. 16, 2007.

(51) Int. Cl. E06B 1/04; E06B 1/60; E06B 3/04; E06B 7/00

(52) U.S. Cl. 52/213; 49/505; 52/745.15; 52/204.1

(57) ABSTRACT

A frame extension having a body with an interior body face, a proximal body face substantially orthogonal to the interior body face, and an attachment channel for receiving a clip is disclosed. A joint is attached to the body and a flange is attached to the joint. The flange has an interior flange face and an exterior flange face substantially parallel to and offset from the interior flange face. The flange is movable from an extended position where the interior flange face and exterior flange face are substantially parallel to the interior body face to a folded position where one of the interior flange face and exterior flange face is substantially abutted to the body.

### CROSS-REFERENCE TO RELATED APPLICATION DATA

This application claims the benefit of the earlier filed U.S. Provisional Patent Application No. 60/918,623 having a filing date of Mar. 16, 2007.

### FIELD OF THE INVENTION

The present invention is related to the field of frames for attachment to wall openings.

### BACKGROUND

A significant inconvenience associated with the installation of conventional frame extensions is that they include no simple provision for attaching the frame extension to a frame. Attaching conventional frame extensions using conventional methods requires that the frame extension be attached to the frame in an inefficient and difficult post-manufacturing process using surface fasteners such as screws or staples being applied on a back surface of the frame extension. Still further, installing conventional frame extensions requires the use of conventional fasteners such as nails, screws, or staples to secure a mitered, butt, or other joint.

Conventional plastic and wooden frame extensions are not fully utilized by the market because of their high relative expense and associated installation problems. Further, the plastic frame extensions commonly require a separate post manufacturing installation procedure using screws because the plastic frame extension is not integrated into the manufactured frame to which it must be attached. Still further, conventional plastic frame extensions have easily recognized negative expansion and contraction properties that cause gaps and/or overlapping in material near “open” mitered, butt, and/or other joints, detracting from the appearance of the frame extension.

Further, manufacturing and installation of conventional frame extensions are associated with high raw material costs that often arise due to solid cross-sectional frame extension shapes. The solid cross-sectional frame extensions require unnecessarily high amounts of raw material resources for their formation.

Another problem with conventional frame extensions is that when a frame extension is applied to a frame, the overall shipping size of the frame with the attached frame extension is inconveniently large. Due to this large shipping size, it is a common belief that for purposes of reducing shipping costs, frame extensions should not be applied to frames prior to arrival at a final destination or final installation site.

### SUMMARY

The present invention is related to, in one embodiment among others, a frame extension having a body with an interior body face, a proximal body face substantially orthogonal to the interior body face, and an attachment channel for receiving a clip. A joint is attached to the body and a flange is attached to the joint. The flange has an interior flange face and an exterior flange face substantially parallel to and offset from the interior flange face. The flange is movable from an extended position where the interior flange face and exterior flange face are substantially parallel to the interior body face to a folded position where one of the interior flange face and exterior flange face is substantially abutted to the body.

### BRIEF DESCRIPTION OF THE DRAWINGS

FIG. 1 is an oblique view of a frame extension according to an embodiment of the present invention;

FIG. 2 is another oblique view of the frame extension of FIG. 1;

FIG. 3 is an orthogonal view of the frame extension of FIG. 1 in a folded position;

FIG. 4 is an orthogonal view of the frame extension of FIG. 1 in an unfolded position;

FIG. 5 is an oblique view of a plurality of frame extensions of FIG. 1, each in a shipping position and attached to a frame;

FIG. 6 is an oblique view of a plurality of frame extensions of FIG. 1, each in an installation position and attached to a frame;

FIG. 7 is an orthogonal view of the frame extension of FIG. 1 adjacent to both a frame and a surface of a wall opening;

FIG. 8 is a cross-sectional view of a frame extension according to another embodiment of the present invention;

FIG. 9 is an oblique view of a fastener according to the present invention;

FIG. 10 is an oblique view of two frame extensions of FIG. 8 joined together by the fastener of FIG. 9;

FIG. 11 is an orthogonal view of a nail fin according to the present invention;

FIG. 12 is an orthogonal view of a frame extension according to another embodiment of the present invention shown with the nail fin of FIG. 11 in a pre-insertion position;

FIG. 13 is an orthogonal view of a frame extension as constructed by a method of constructing a frame extension according to an embodiment of the present invention;

FIG. 14 is an orthogonal view of a frame extension as constructed by another method of constructing a frame extension according to another embodiment of the present invention;

FIG. 15 is an oblique view of the frame extension of FIG. 1 attached to a frame in a shipping position; and

FIG. 16 is an oblique view of the frame extension of FIG. 1 attached to a frame in an installation position.

### DETAILED DESCRIPTION OF THE EMBODIMENTS

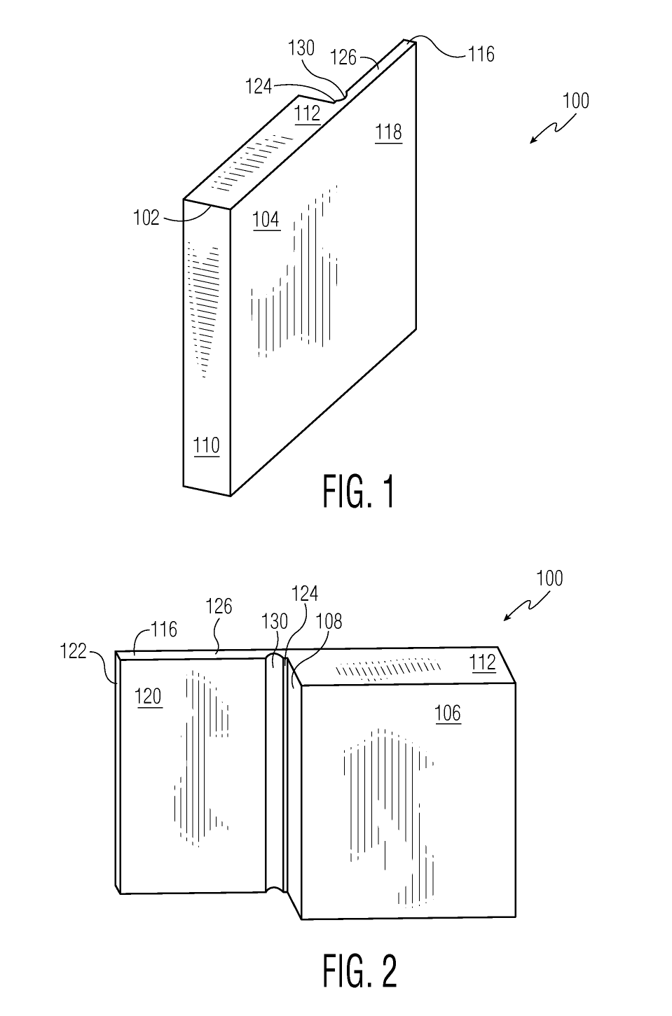

Referring now to FIGS. 1-4 in the drawings, a frame extension 100 according to the present invention is illustrated. The frame extension 100 comprises a substantially box-shaped body 102. Body 102 comprises an interior body face 104, an exterior body face 106, a proximal body face 108, a distal body face 110, a first body end 112, and a second body end 114. A flange 116 is attached to body 102 in a plane substantially parallel to proximal body face 108. Flange 116 comprises an interior flange face 118, an exterior flange face 120, a proximal flange face 122, a distal flange end 124, a first flange end 126, and a second flange end 128. Flange 116 generally extends from interior flange face 118 to exterior flange face 120 between proximal flange face 122 and distal flange end 124 and between first flange end 126 and second flange end 128 to form a substantially box-shaped structure. The flange 116 is flexibly attached to body 102 by a joint 130 on the flange 116 near the proximal body face 108 and the distal flange end 124. In this embodiment, the joint 130 comprises a generally concave channel extending substantially along the flange 116 from the first flange end 126 to the second flange end 128 and near the intersection of the distal flange end that is integrally attached to body 102. Of course, in an alternative embodiment where the material of the joint is sufficiently flexible, the joint may not take the shape of a concavity, but rather, may be the same thickness as the flange. Still further, in alternative embodiments of the frame extension, the joint may comprise a deeper or more shallow concavity than the concave channel shown in FIGS. 1 and 2. In this embodiment, flange 116 is substantially thinner between interior flange face 118 and exterior flange face 120 than body 102 between interior body face 104 and exterior body face 106. Further, it will be appreciated that the above-described thickness of flange 116 is exaggerated to appear larger in FIGS. 1-4 for increased clarity in describing the embodiment. Generally, flange 116 is much thinner than body 102.

The frame extension 100 may be manufactured by any suitable technique, including but not limited to being extruded, formed, molded, pressed, and/or milled using any variety of suitable materials. More specifically, extrusion and co-extrusion techniques may be implemented to form frame extension 100 (discussed infra). Alternatively, frame extension 100 may be molded into the proper shape by injection molding techniques, pressed into the proper shape using thermoplastic, fiber, or composite construction, or produced utilizing a vacuum forming or extrusion methods. In this embodiment, the frame extension 100 is constructed by extrusion or co-extrusion of both cellular and rigid PVC. However, it will be appreciated that manufacturing materials such as, polystyrene, polyethylene, PET thermoplastic, or any suitable combination of thermoplastic, fiber, composite, and/or metal may be used. It will further be appreciated that an exterior color of the frame extension 100 may be achieved simply by appropriate material selection or by the inclusion of coloring agents or the like.

In this embodiment, body 102 preferably comprises cellular PVC to achieve a wooden appearance, thereby preventing the need for an exposed surface of the frame extension to be painted. However, it will be appreciated that the body 102 may alternatively comprise wood, rigid PVC, MDF, or any other suitable composite material. Further, different embodiments of the present invention may comprise a body such as body 102 having thicknesses, sizes, widths, and surface textures selected which to accommodate matching the decorative features of the frame (discussed infra) and/or associated door or window with which the present invention may be associated.

In this embodiment, flange 116 comprises rigid PVC and is integrally attached to the body 102 by means of thermal bonding that takes place during the above-described co-extrusion process. In alternative embodiments, the flange may be joined to the body 102 in a secondary operation where the flange 116 comprises wood, rigid PVC, cellular PVC, or other composite materials using fasteners such as nails, screws, staples, glue, or other suitable fasteners. In a further alternative embodiment, the entire flange 116 may be formed from a flexible material. Of course, where the flange is sufficiently flexible the joint may not take the shape of a concavity, but rather, may simply be a portion of the flange that is sufficiently flexible to allow the required bending. Regardless of the way the flange 116 is constructed and attached to body 102, flange 116 is well suited for attachment to a frame (discussed infra) using any suitable fastener. In this embodiment, flange 116 may be attached to a frame using staples and/or nails in such a manner that flange 116 is attached to the frame 200 while body 102 is movable between shipping positions and an installation positions (discussed infra).

In this embodiment, the joint 130 comprises a co-extruded composite of rigid PVC for forming the body 102 and portions of the flange 116 while a flexible material such as flexible PVC, TPE, and/or rubber is used for the purpose of forming joint 130 and enabling the flexibility of joint 130. Of course, in an embodiment where the entire flange is flexible, there is no need for a joint such as joint 130 and the flange 116 itself may be bent into the shipping positions and the installation positions.

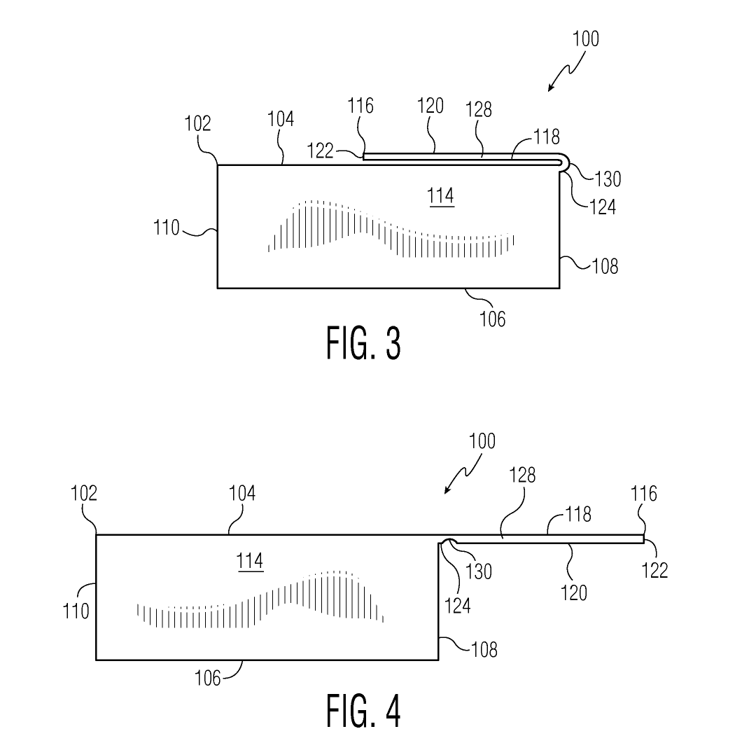

Referring now to FIGS. 3 and 4, frame extension 100 is operable, in one use, at least between a folded position shown in FIG. 3 and an extended position shown in FIG. 4. Frame extension 100 is easily moved from the folded position to the extended position through the use of joint 130. In the folded position shown in FIG. 3, flange 116 lies in relationship to body 102 so that interior flange face 118 generally faces and/or abuts interior body face 104. In the extended position shown in FIG. 4, flange 116 lies in relationship to body 102 so that interior flange face 118 and interior body face 104 in a substantially the same direction and lie substantially coplanar with proximal flange face 122 facing substantially the same direction as proximal body face 108.

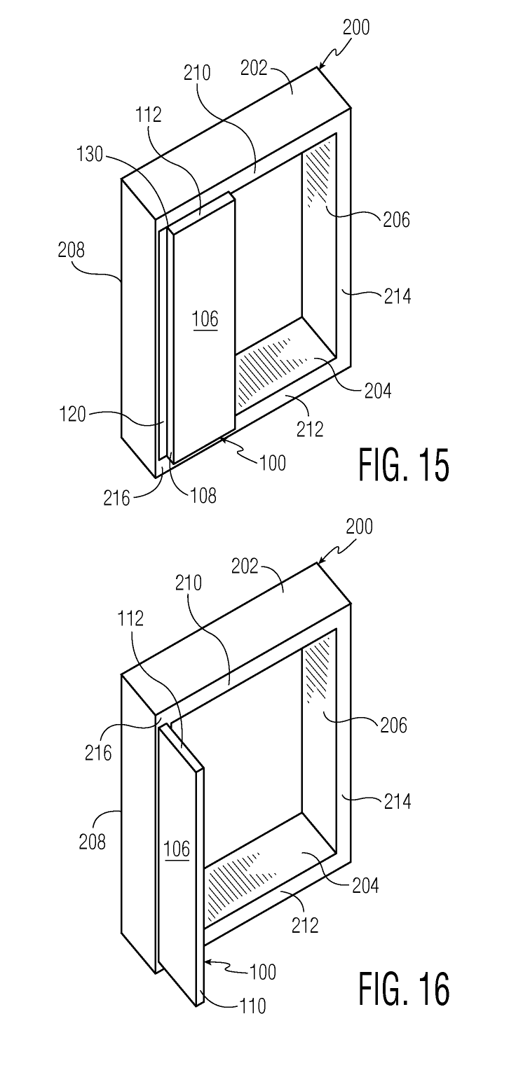

Still referring to FIG. 4, frame extension 100 is operable, in another use (see FIGS. 15 and 16), between the position shown in FIG. 4 and a folded position different from that folded position shown in FIG. 3 (see FIG. 16). Specifically, the frame extension 100 is operable between the position shown in FIG. 4 to a position where the exterior flange face 120 is substantially adjacent the proximal body face 108. Of course, where joint 130 is sufficiently flexible, frame extension 100 is operable between the position shown in FIG. 3 and the position in which the exterior flange face 120 is substantially adjacent the proximal body face 108. Such change in position of frame extension 100 may be accomplished by rotating the flange 116 with respect to body 102 by approximately 270° about the joint 130.

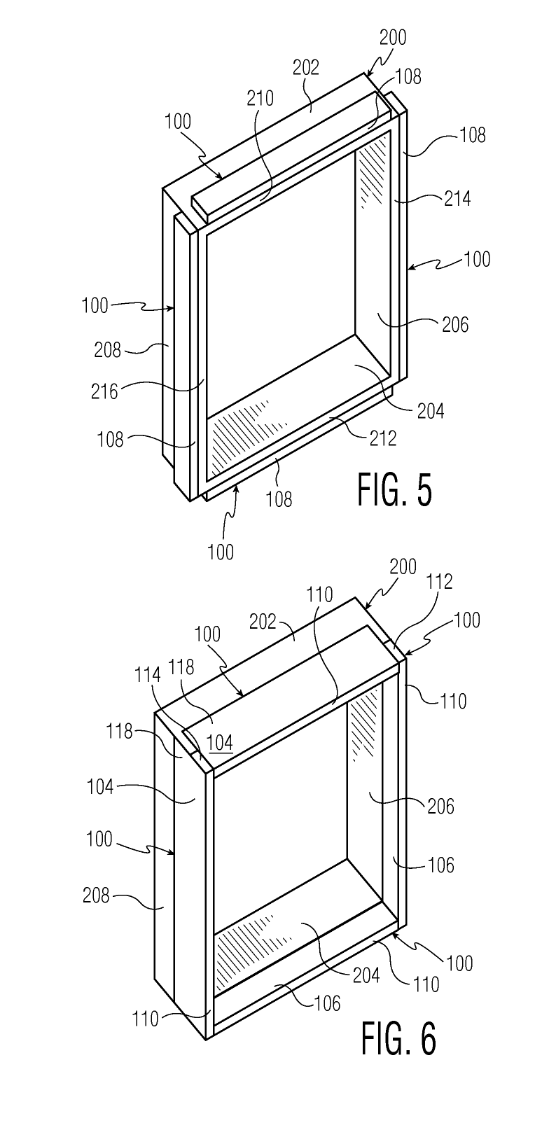

Referring now to FIG. 5, a plurality of frame extensions 100 are shown as attached to a frame 200 and each in a first shipping position. Frame 200 is a simplified representation of an exterior portion of a window, door, or other frame well suited for installation in an opening of a wall. Frame 200 comprises an upper frame element 202, a lower frame element 204, a right frame element 206, and a left frame element 208 joined together to form the substantially rectangular frame 200. The frame 200 may be a portion of a modular door or modular window assembly. The upper frame element 202, lower frame element 204, right frame element 206, and left frame element 208 comprise an upper front face 210, a lower front face 212, a right front face 214, and a left front face 216, respectively. Upper frame element 202 lies generally parallel to and offset from lower frame element 204 and are joined on one side of upper frame element 202 and lower frame element 204 by right frame element 206 and on the opposite side by left frame element 208. Right frame element 206 and left frame element 208 lie generally parallel to and offset from each other. With the plurality of frame extensions 100 attached to the frame 200 and in the first shipping position, the proximal body faces 108 of the frame extensions 100 are substantially located coplanar with the upper front face 210, lower front face 212, right front face 214, and left front face 216 so that the frame 200 with attached frame elements 100 does not increase the overall depth of the assembly as generally measured (for example) from a back face (not shown) of the frame 200 facing substantially the same direction as the distal body face 110 to the upper front face 210. Frame extensions 100 are folded along joints 130 so that while flanges 116 are fastened to the frame 200, the flanges 116 are also between the bodies 102 and the respective frame elements to which the flanges 116 are attached. This arrangement of folding the attached frame extensions 100 to the first installation position provides an assembly that is more easily shipped in bulk quantities and allows a plurality of the assemblies to be stacked to allow approximately one-quarter to twice or more the quantity of frames 200 having attached frame extensions 100 (in the first shipping position) to be shipped within the same shipping volume as compared to frames 200 having conventional frame extensions. It will be appreciated that in an alternative embodiment of the invention that is substantially similar to the embodiments of FIG. 5, the lower frame element 204 may optionally have not frame extension 100 associated with the lower frame element 204. Where no frame extension 100 is associated with the lower frame element 204, a separate stool (not shown) may optionally be used to extend the lower frame element 204, or sill. In fact, in most conventional applications of the frame extension 100 to a conventional frame such as frame 200, no frame extension 100 would be attached to the lower frame element 204. One reason for not installing a frame extension 100 to a lower frame element is that installation of a frame extension 100 to the lower frame element 204 is that doing so would prevent or otherwise impede installation of conventional stools, sills, or other traditional structures.

Referring now to FIG. 6, a plurality of frame extensions 100 are shown as attached to the frame 200 and each in the first installation position. With the frame extensions 100 in this first installation position, the proximal body faces 108 of the frame extensions 100 are substantially adjacent to and face the upper front face 210, the lower front face 212, the right front face 214, and the left front face 216. Also, with the frame extensions 100 in this first installation position, the interior body face 104 of each frame extension 100 is substantially coplanar with the interior flange face 118 of the respective frame extension 100 so that the distal body faces 110 face away from the upper front face 210, the lower front face 212, the right front face 214, and the left front face 216. The frame extensions 100 may be secured in this position using any suitable fastener and the fasteners may be used to attach adjacent frame extensions 100 to each other. Securing the frame extensions 100 to each other is made easier since the frame extensions are substantially held in place by their connection to the frame 200 by the flanges 116. Once the frame extensions 100 are secured in the first installation position, the entire assembly may be installed into an opening in a wall. The above described process allows the exterior body faces of the frame extensions 100 to remain un-marred during and after the installation process. Further, this embodiment of frame extension 100 is resistant to expansion and contraction because it is secured the entire length of the frame 200.

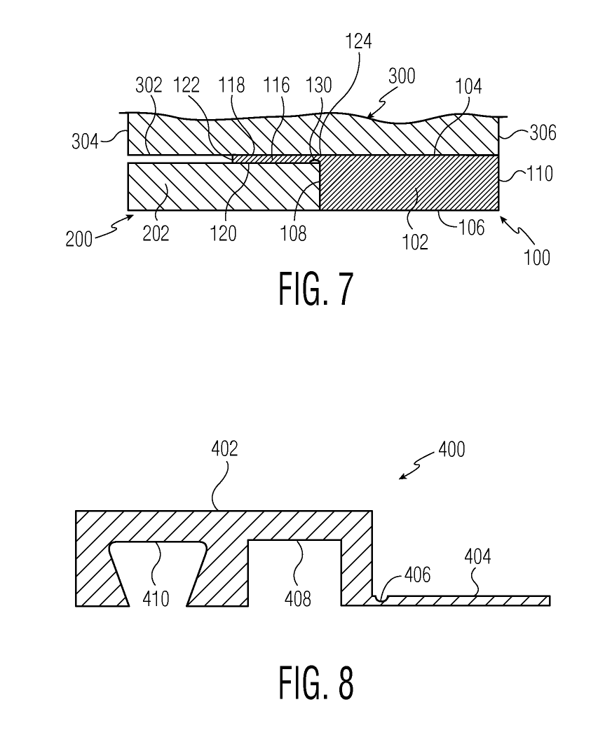

Referring now to FIG. 7, a partial cross-sectional view of a frame 200 with an attached frame extension 100 is shown positioned for attachment to an opening in a simplified representation of a wall 300. The wall 300 comprises a mounting face 302, a right wall face 306, and a left wall face 308. When the frame 200 with the attached frame extension 100 is positioned for attachment to the wall 300, the interior body face 104 and the interior flange face 118 face and are substantially adjacent to the mounting face 302. Similarly, the frame element (upper frame element 202 in this example) is substantially adjacent to the mounting face 302. However, as clearly shown in FIG. 7, the flange 116 is substantially interposed between the mounting face 302 and a portion of the upper frame element 202. It should be noted that FIG. 7 is not to scale and that flange 116 is sufficiently thin to prevent any difficulty in properly attaching upper frame element 202 to wall 300. Once positioned as shown, the frame 200 and the frame extension 100 may be attached to the wall 300 using suitable fasteners. Further, it will be appreciated that a shim or other spacer may be interposed between mounting face 302 and one or more of the interior flange face 118, the interior body face 104, and/or the faces of frame 200 that are not covered by any part of the extension 100.

Referring now to FIG. 8, a second embodiment of a frame extension according to the present invention is illustrated. Frame extension 400 is substantially similar to frame extension 100. Frame extension 400 comprises a body 402 substantially similar to body 102 in overall dimension, a flange 404 substantially similar to flange 116, and a joint 406 substantially similar to joint 130. However, frame extension 400 further comprises two features not part of frame extension 100. A first difference is the existence of a material reducing channel 408. In this embodiment, the material reducing channel 408 is essentially a rectangular channel extending along the longitudinal length of the frame extension 400. The material reducing channel 408 is formed in the frame extension 400 in an effort to dramatically reduce the amount of raw material required to produce the frame extension 400 as compared to the amount of raw material required to produce the frame extension 100. Another difference is that frame extension 400 comprises an attachment channel 410. In addition to further reducing the amount of raw material required to produce the frame extension 400, the attachment channel 410 is well suited for accepting clips 500 (discussed infra) for attaching adjacent frame extensions 400 to each other. In this embodiment, the attachment channel is formed substantially as a dovetail groove extending along the longitudinal length of the frame extension 400 substantially parallel to the material reducing channel 408. In this embodiment, the material reducing channel 408 and the attachment channel 410 are formed during an initial extrusion of the frame extension 400. However, the channels 408, 410 may alternatively be formed by removing material from a substantially solid cross-section after an initial extrusion process. In an alternative embodiment (not shown) the attachment channel may comprise a mechanically interlocking protrusion to interact with a complementary interlocking clip (not shown). It will be appreciated that the material reducing channel 408 and the attachment channel 410 may alternatively be shaped differently than depicted in FIG. 8. Particularly, the attachment channel may be shaped in any manner suitable for accepting a complementary clip.

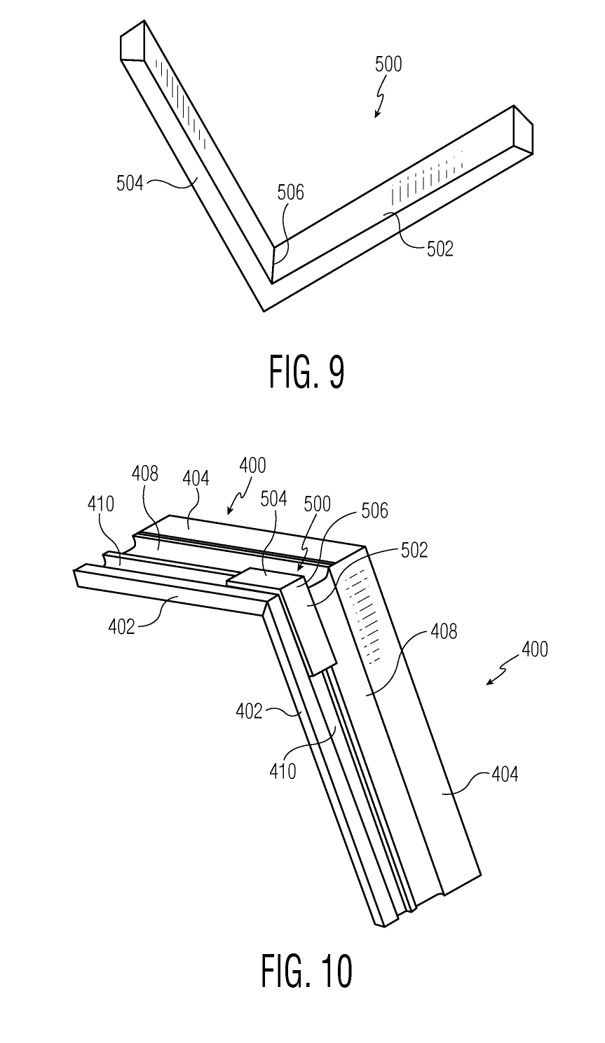

Referring now to FIG. 9, a clip 500 according to an embodiment of the present invention is illustrated. Clip 500 comprises a first clip leg 502 and a second clip leg 504 joined to the first clip leg 502 at a vertex 506. The clip legs 502, 504 comprise a substantially dovetail cross-sectional shape that complements the substantially dovetail shape of the attachment channel 410. The first clip leg 502 and second clip leg 504 are oriented substantially perpendicular to each other so that the vertex 506 joins the clip legs 502, 504 at an angle of approximately 90°.

Referring to FIG. 10, two frame extensions 400 are shown as being oriented end to end to each other in a perpendicular manner so that they form a right angle. To secure the two frame extensions 400 in this position, a clip 500 is used in conjunction with the attachment channels 410. Specifically, the first clip leg 502 is placed in a frictional or interference fit with one of the attachment channels 410 while the second clip leg 504 is placed in a frictional or interference fit with the remaining attachment channel 410. In this way, clips 500 can be used to join frame extensions 400 instead of or in addition to conventional fasteners. The length of legs 502, 504 may be any length suitable for ensuring stable attachment of the joined frame extensions 400.

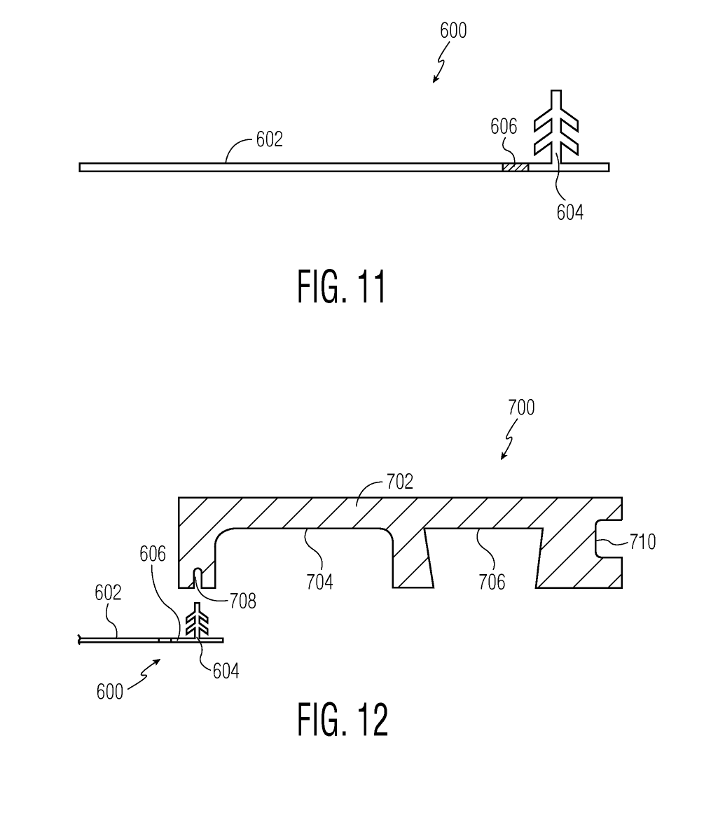

Referring to FIG. 11, a nail fin 600 according to the present invention is illustrated. Nail fin 600 comprises a nail fin flange 602 attached to an expanding anchor 604 by a flexible joint 606. Nail fin flange 602 is a substantially thin plate-like member much like flange 116. An optional expanding anchor 604 is an insertion anchor well suited for easy insertion into a properly sized receptacle, however, once expanding anchor is inserted into the receptacle, the expanding anchor resists removal from the receptacle.

Referring to FIG. 12, a frame extension 700 according to another embodiment of the present invention is illustrated. Frame extension 700 comprises a body 702 substantially similar to body 402. Body 702 comprises a material reducing channel 704 substantially similar to material reducing channel 408, an attachment channel 706 substantially similar to attachment channel 410, however, body 402 is not attached to a flange like flange 404. Instead, body 402 comprises a nail fin channel 708 for receiving the expanding anchor 604, thereby allowing connection of the nail fin 600 to the frame extension 700. When attached together, frame extension 700 and nail fin 600 perform substantially the same function as frame extension 400 in an extended position. FIG. 12 shows nail fin 600 located in a pre-insertion position where the optional expanding anchor 604 is aligned with an optional nail fin channel 708 for insertion into optional nail fin channel 708. Of course, if nail fin 600 comprises the optional expanding anchor 604, it is appropriate for frame extension 700 to comprise the complementary optional nail fin channel 708 for receiving the optional expanding anchor 604. In an alternative embodiment where nail fin 600 does not comprise the optional expanding anchor 604, nail fin channel 708 is not used for joining the nail fin 600 to the frame extension 700. Instead, the nail fin 600 without the optional expanding anchor 604 may be simply placed adjacent the frame extension 700 and stapled, nailed, adhered, or otherwise attached to the frame extension 700. Frame extension 700 further comprises a casing channel 710 that extends along a distal body face 712 of frame extension 700 that is substantially similar to distal body face 110 of frame extension 100. Casing channel 710 is well suited for receiving an anchor or other securing component of a casing (not shown) so that a casing can quickly and easily be secured to the frame extension 700.

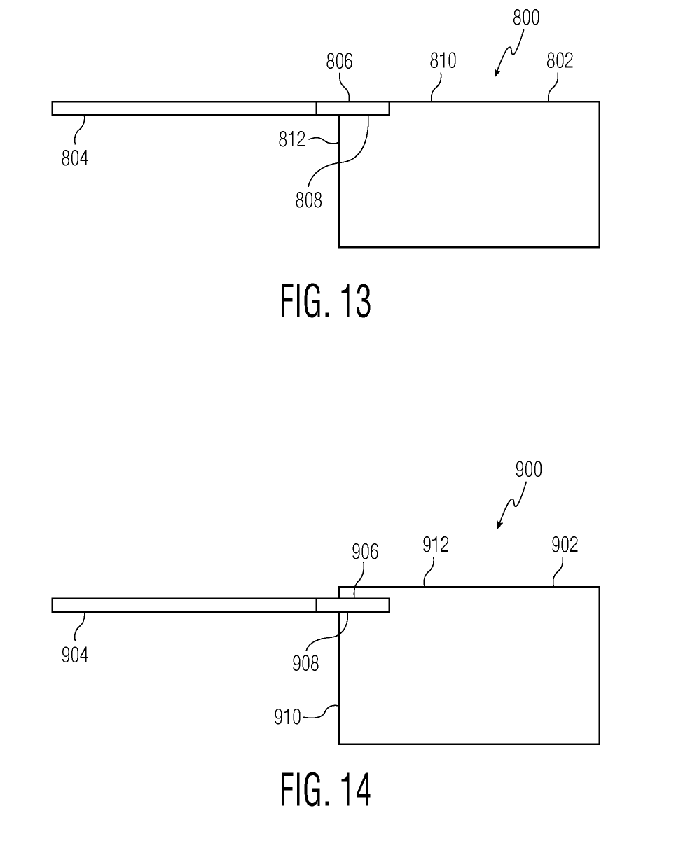

Referring to FIG. 13, a frame extension 800 according to another embodiment of the present invention is illustrated. Frame extension 800 comprises a body 802 substantially similar in form and function to body 102 and a flange 804 substantially similar to flange 116 in form and function. Frame extension 800 further comprises a flexible joint 806 that flexibly joins the body 802 to the flange 804. The body 802 and the flange 804 are constructed by extrusion or co-extrusion of both cellular and rigid PVC. However, it will be appreciated that manufacturing materials such as polystyrene, polyethylene, PET thermoplastic, or any suitable combination of thermoplastic, fiber, composite, and/or metal may be used. Joint 806 comprises a flexible material such as flexible PVC, TPE, and/or rubber, thereby enabling the flexibility of joint 806. Frame extension 800 operates in substantially the same manner as frame extension 100. However, frame extension 800 is manufactured and constructed in a manner slightly different from that of frame extension 100. First, the joint 806 does not comprise a concave shape like the concave shape of joint 130, although it could in a further alternative embodiment. Also, the material that forms the joint 806 is joined with the body 802 in a recessed step 808 of the body 802, where the recessed step 808 is a setback or removed portion of body 802 at an intersection of a first step side 810 of the body 802 and a second step side 812 of the body 802. During manufacture of the frame extension 800, the individual parts of the frame extension 800, the body 802, the flange 804, and the joint 806, may be joined together in one of a number of ways. One method of manufacturing the frame extension 800 is to extrude or otherwise form the parts of the frame extension 800 individually and later assemble them using conventional bonding and/or fusing techniques. Another method of manufacturing the frame extension 800 is to co-extrude at least two of the parts of the frame extension 800 simultaneously, and thereafter, pass the parts (the body 802, the flange 804, and the joint 806) through a heated common die. The heat and pressure applied during the passage of the parts of the frame extension 800 through the common die effectively fuse the parts together to form the frame extension 800.

Referring to FIG. 14, a frame extension 900 according to another embodiment of the present invention is illustrated. Frame extension 900 comprises a body 902 substantially similar in form and function to body 102 and a flange 904 substantially similar to flange 116 in form and function. Frame extension 900 further comprises a flexible joint 906 that flexibly joins the body 902 to the flange 904. The body 902 and the flange 904 are constructed by extrusion or co-extrusion of both cellular and rigid PVC. However, it will be appreciated that manufacturing materials such as polystyrene, polyethylene, PET thermoplastic, or any suitable combination of thermoplastic, fiber, composite, and/or metal may be used. Joint 906 comprises a flexible material such as flexible PVC, TPE, and/or rubber, thereby enabling the flexibility of joint 906. Frame extension 900 operates in substantially the same manner as frame extension 100. However, frame extension 900 is manufactured and constructed in a manner slightly different from that of frame extension 100. First, the joint 906 does not comprise a concave shape like the concave shape of joint 130, although it could in a further alternative embodiment. Also, the material that forms the joint 906 is joined with the body 902 in a recessed channel 908 of the body 902, where the recessed channel 908 is a thin setback or removed portion of body 902 along the length of a channel side 910 of the body 902. The recessed channel 908 is offset only slightly from an upper side 912 of the body 902. FIG. 14 shows how joint 906 is located within the recessed channel 908 of the body 902. During manufacture of the frame extension 900, the individual parts of the frame extension 900, the body 902, the flange 904, and the joint 906, may be joined together in one of a number of ways. One method of manufacturing the frame extension 900 is to extrude or otherwise form the parts of the frame extension 900 individually and later assemble them using conventional bonding and/or fusing techniques. Another method of manufacturing the frame extension 900 is to co-extrude at least two of the parts of the frame extension 900 simultaneously, and thereafter, pass the parts (the body 902, the flange 904, and the joint 906) through a heated common die. The heat and pressure applied during the passage of the parts of the frame extension 900 through the common die effectively fuse the parts together to form the frame extension 900.

Referring now to FIGS. 15 and 16, a frame extension 100 is shown as attached to a frame 200 in a manner different from that shown in FIGS. 5 and 6. Specifically, the frame extension 100 is shown installed to the frame 200 in a manner that allows the frame extension 100 to operate by changing from the extended position shown in FIG. 4 to a second installation position where the exterior flange face 120 is substantially adjacent the proximal body face 108. The frame 100 of FIGS. 15 and 16 is attached, in this embodiment, to the frame 200 generally by placing the interior flange face 118 of the frame extension 100 to a left front face 216 of the frame 200. As shown, the flange 116 is sized so that it does not extend beyond the bounds of the left front face 216. This placement allows the frame extension 100 to be operated from a second shipping position as shown in FIG. 15 to the second installation position as shown in FIG. 16. In other applications, frame extensions 100 could optionally be attached to the upper front face 210, the lower front face 212, and/or the right front face 214. With the frame extension 100 attached to the frame 200 in the second shipping position as shown in FIG. 15, the frame extension 100 does not add to the overall width or height of the assembly. Accordingly, the required shipping volume for the assembly in the second shipping position shown in FIG. 15 is less than the shipping volume that would be required for the assembly in the second installation position shown in FIG. 16.

The foregoing illustrates some of the possibilities for practicing the invention. Many other embodiments are possible within the scope and spirit of the invention. Therefore, it is intended that the foregoing description be regarded as illustrative rather than limiting, and that the scope of the invention is given by the appended claims together with their full range of equivalents.

What is claimed is:

1. A frame extension, comprising:
a body having an interior body face, a proximal body face substantially orthogonal to the interior body face, and an attachment channel for receiving a clip;
a joint attached to the body; and
a flange attached to the joint, the flange having an interior flange face and an exterior flange face substantially parallel to and offset from the interior flange face, the flange being movable from an extended position where the interior flange face and exterior flange face are substantially parallel to the interior body face to a folded position where one of the interior flange face and exterior flange face is substantially abutted to the body.

2. The frame extension according to claim 1, wherein the attachment channel comprises a dovetail shape.

3. The frame extension according to claim 1, the body further comprising:
a material reducing channel.

4. The frame extension according to claim 1, wherein the joint is integrally formed with the flange.

5. The frame extension according to claim 1, wherein the body is thick and wherein the flange is thin.

6. The frame extension according to claim 1, wherein the entire flange is flexible and the joint is a portion of the flange.

7. The frame extension according to claim 1, the body further comprising:
a casing channel for receiving an anchor of a casing.

8. A frame extension for attachment to a frame, comprising:
a thick body having an interior body face, a proximal body face substantially orthogonal to the interior body face, and an attachment channel for receiving a clip;
a joint attached to the body; and
a thin flange attached to the joint, the flange having an interior flange face and an exterior flange face substantially parallel to and offset from the interior flange face, the flange being movable from an extended position where the interior flange face and exterior flange face are substantially parallel to the interior body face to a folded position where one of the interior flange face and exterior flange face is substantially abutted to the body.

9. The frame extension according to claim 8, the body further comprising:
an attachment channel for receiving a clip.

10. The frame extension according to claim 8, wherein the attachment channel comprises a dovetail shape.

11. The frame extension according to claim 8, wherein the flange is movable by approximately 270° with respect to the body between a position where the interior flange face is substantially abutted to the interior body face and a position where the exterior flange face is substantially abutted to the proximal body face.

12. The frame extension according to claim 8, wherein the joint is attached to the body substantially along an intersection of the interior body face and the proximal body face.

13. The frame extension according to claim 8, the body further comprising:
a material reducing channel.

14. The frame extension according to claim 8, the body further comprising:
a casing channel for receiving an anchor of a casing.

15. The frame extension according to claim 8, wherein the body, the joint, and the flange are integrally formed in an extrusion process.

16. A frame extension for attachment to a frame, comprising:
a body having an interior body face and a nail fin channel for receiving an anchor of a nail fin;
wherein when the nail fin anchor is received within the nail fin channel and the nail fin is attached to the frame, the body is movable to an extended position where the interior body face is substantially coplanar with a flange of the nail fin.

17. The frame extension according to claim 16, the body further comprising:
a casing channel for receiving an anchor of a casing.

18. The frame extension according to claim 16, the body further comprising:
an attachment channel for receiving a clip.

19. The frame extension according to claim 18, wherein the attachment channel comprises a dovetail shape.

20. The frame extension according to claim 16, the body further comprising:
a material reducing channel.

21. A method of making a frame extension, comprising:
forming a body;
forming a flange;
forming a joint for joining the body to the flange; and
passing the body, the flange, and the joint through a common die.

22. The method according to claim 21, wherein at least two of the body, the flange, and the joint are formed through a co-extrusion process.

23. The method according to claim 21, wherein the common die is heated to fuse the joint to at least one of the body and the flange.

24. The method according to claim 21, wherein the joint is attached to the body at a recessed step of the body.

25. The method according to claim 21, wherein the joint is attached to the body in a recessed channel of the body.

26. The method according to claim 21, wherein the body and the flange comprise substantially the same material.

27. The method according to claim 21, wherein each of the body, the flange, and the joint are formed separately.

28. The method according to claim 21, wherein the joint is attached to the body during the passing of the joint and the body through the common die.
